(19) United States
(12) Patent Application Publication
(10) Pub. No.: US 2019/0021158 A1
(43) Pub. Date: Jan. 17, 2019

(54) LASER-DRIVEN LIGHT SOURCE DEVICE

(71) Applicant: USHIO DENKI KABUSHIKI KAISHA, Tokyo (JP)

(72) Inventor: Shinichiro NOZAKI, Tokyo (JP)

(73) Assignee: USHIO DENKI KABUSHIKI KAISHA, Tokyo (JP)

(21) Appl. No.: 16/031,174

(22) Filed: Jul. 10, 2018

(30) Foreign Application Priority Data
Jul. 13, 2017 (JP) 2017-136778

(51) Int. Cl. H05G 2/00; H01S 3/091; H01S 3/00; G21K 1/06; H01S 3/094; H01S 3/0941

(52) U.S. Cl. CPC H05G 2/008; H01S 3/0912; H01S 3/0941; G21K 1/06; H01S 3/094076; H01S 3/0071

(57) ABSTRACT

A laser-driven light source device includes a laser oscillation unit configured to emit laser light, and a plasma vessel configured to contain and seal a discharge medium therein. The laser-driven light source device also includes an optical system configured to condense the laser light emitted from the laser oscillation unit, and direct the laser light to an inside of the plasma vessel to generate a plasma. The laser oscillation unit includes a control unit configured to perform an on/off control on the generation of the laser light to modulate an output of the laser light such that the laser light is generated during an on-time of several μsec to several msec and the laser light is not generated during an off-time. The off-time is decided such that the plasma in the plasma vessel does not disappear.

### FIELD OF THE INVENTION

The present invention relates to a laser-driven light source device and especially relates to a laser-driven light source device that intermittently irradiates an inside of a plasma vessel with laser light.

### RELATED ART

Recently, an ultraviolet light source that receives a large amount of input electric power has been used in a method of manufacturing processed products such as semiconductors, liquid crystal substrates, and color filters. Such light source generates high-output ultraviolet rays.

In order to generate high-output ultraviolet rays, especially ultraviolet rays in a short wavelength range, there has been proposed a laser-driven light source that lights up in a tubular bulb (or lamp) for point light source between electrodes and then irradiates plasma with laser light to generate continuous high-luminance light. For example, Japanese Patent Application Laid-Open Publication No. 2009-532829 discloses such laser-driven light source.

FIG. 5 of the accompanying drawings schematically shows a laser-driven light source of Japanese Patent Application Laid-Open Publication No. 2009-532829. As illustrated in FIG. 5, a laser-driven light source 20 includes a chamber (tubular bulb) 21, a pair of electrodes 32 and 33, and a laser oscillation unit 24. An ionic medium (discharge medium) such as mercury and noble gas is sealed in the chamber 21. The two electrodes 32 and 33 serve, in combination, as an ignition source to ionize the ionic medium in the chamber 21. The laser oscillation unit 24 generates a continuous or pulse-shaped laser energy.

The laser oscillation unit 24 is a diode laser that outputs laser light 25 via an optical fiber 26. The optical fiber 26 supplies a collimator 27 with the laser light 25. The collimator 27 practically and mutually parallels the laser light 25. The collimator 27 directs the parallel laser light 25 to a beam expander 28. The beam expander 28 enlarges the sizes of laser light 25. The beam expander 28 directs the laser light 25 to an optical lens 29. The optical lens 29 condenses the laser light 25 to generate small-diameter laser light 25 oriented to a region in which a plasma 30 is present in the chamber 21.

The laser-driven light source 20 generates a discharge in the chamber 21 by using the ignition source including the anode 32 and the cathode 33 to ionize the ionic medium in the chamber 21. Then, the laser-driven light source 20 supplies the ionized medium with the laser energy to maintain or generate the plasma 30, which emits high-illuminance light 31.

In the laser-driven light source 20, the temperature of the plasma 30 rises until it is balanced by radiation and other processes. Eventually, the temperature of the plasma 30 reaches an extremely high temperature such as 10,000 degrees K to 20,000 degrees K. Thus, the ultraviolet energy with the short wavelength radiated from the high-temperature plasma increases.

Japanese Patent Application Laid-Open Publication No. 2009-532829 also describes use of pulse laser light as the ignition source, rather than the use of the above-described pair of electrodes.

If the pulse laser light is used as the ignition source, pulse laser light having a peak energy in the order of megawatts (MW), a pulse width in the order of femtosecond (fs) to nanosecond (ns), and a repeated cycle in the order of msec (ms) is employed.

The pulse laser light features the large peak energy, but the pulse width is extremely short and the repeated cycle cannot be short; therefore, its average energy over the time is small. Accordingly, even when the irradiation of pulse laser light ensures generating the plasma (firing source) in the chamber, the repeated pulse laser light alone cannot steadily maintain the generated plasma.

In the start-up (ignition) period of the light source of this type, therefore, as illustrated in FIG. 6A of the accompanying drawings, CW (Continuous Wave) laser light is directed to the plasma chamber, and pulse laser light is also emitted to the plasma chamber in a superimposing manner. After the start-up period, as illustrated in FIG. 6B, the plasma (firing source) generated by the irradiation of the pulse laser light is maintained by the energy supplied from the CW laser light.

In the meantime, as semiconductor integrated circuits are miniaturized and highly integrated, an ultraviolet light source used to the exposure process needs to emit ultraviolet light with a shorter wavelength. Especially, vacuum ultraviolet light (VUV light) with a wavelength of 200 nm or less have been used for semiconductor exposure and other fields. For example, the vacuum ultraviolet light is applied to a technique that performs patterning of a self-organized monomolecular film by causing a chemical reaction with direct light using the VUV light and a mask, without the use of a pattern forming step with a photoresist.

The light radiated from the plasma can be considered as a radiation from a black body, and the radiation spectrum follows the Planck formula. In the Planck formula, the increase in the plasma temperature causes the spectrum to have a large amount of component in the short wavelength range.

If such laser-driven light source should increase the components of the ultraviolet rays with the short wavelength included in the plasma light radiated from the plasma vessel, a power (energy per hour: watt) of the laser supplied into the plasma formed in the plasma vessel may be increased.

FIGS. 7A to 7D of the accompanying drawings conceptually illustrate this phenomenon. Suppose that the plasma temperature is T1 (FIG. 7C) when the laser power is P1 (FIG. 7A), and the plasma temperature is T2 (FIG. 7D) when the laser power is P2 (FIG. 7B). Then, the plasma temperature relationship is represented by T1<T2 when the laser power relationship is represented by P1<P2.

In this situation, a comparison of areas A1 and A2 of certain ultraviolet rays with a wavelength λ or less between the cases of the laser powers being P1 and P2 in the optical spectrum of the black body radiation is turned out to be A1<A2, as shown in FIGS. 7C and 7D.

This derives from that increasing the laser power P supplied into the plasma not only simply increases the optical output but also increases the plasma temperature T. This shifts the spectrum of the black body radiation to the short wavelength side (to the left in FIGS. 7C and 7D). This, in turn, allows increasing the ultraviolet components (a proportion of the ultraviolet output to the entire optical output) in the short wavelength range and therefore is efficient.

However, a large-output CW laser source needs to be prepared to increase the laser power aiming to increase the ultraviolet components in the short wavelength range. This results in a large-scale device and a large cost.

Additionally, the large-output laser power is introduced to the inside of the chamber (bulb), and therefore the laser power applies an excessive thermal load onto the chamber, causing bulb damage.

In order to avoid these drawbacks, if the pulse laser used at the start-up of the light source device is also used to maintain the plasma, as described above, the pulse width is in the order of nsec and the repeated cycle is in the order of msec although the pulse laser can input a large amount of energy with one pulse. This causes a problem that the pulse laser alone cannot maintain the plasma.

### SUMMARY

An object of the present invention is to provide a laser-driven light source device that can efficiently generate vacuum ultraviolet rays without a large-output CW laser oscillation unit.

According to one aspect of the present invention, there is provided a laser-driven light source device that includes a laser oscillation unit configured to emit laser light, and a plasma vessel configured to contain and seal a discharge medium therein. The laser-driven light source device also includes an optical system configured to condense the laser light emitted from the laser oscillation unit, and direct the laser light to an inside of the plasma vessel to generate a plasma. The laser oscillation unit includes a control unit configured to perform an on/off control on the generation of the laser light to modulate an output of the laser light such that the laser light is generated during an on-time of several μsec to several msec and the laser light is not generated during an off-time. The off-time is decided such that the plasma in the plasma vessel does not disappear.

The laser-driven light source device holds a shape of a spectrum of a black body radiation to a shape similar to a shape, which is formed when a large-output CW laser is emitted to the plasma vessel, without use of a large-output CW laser oscillation unit. The laser-driven light source device efficiently obtains vacuum ultraviolet rays without a change in a ratio of a vacuum ultraviolet region to the remaining region.

The laser oscillation unit may include a pumping device, a laser resonator, and an electricity feeding device, in addition to the control unit. The electricity feeding device may be configured to feed a power to the pumping device. The control unit may be configured to control the electricity feeding device. The control unit may be configured to perform the on/off control on the electricity feeding device such that the on-time becomes several μsec to several msec and the off-time becomes the period that is sufficiently short to avoid the disappearing of the plasma.

The plasma vessel may include a body, a light incident window (light inlet or entrance), and a light emission window (light outlet or exit). The body may have a reflecting surface, and the reflecting surface may be a concave surface. The incident window may be disposed at a rear opening of the body. The emission window may be disposed at a front opening of the body. A closed and sealed space may be formed by the body, the incident window, and the emission window. The sealed space may contain and seal the discharge medium therein. The laser light from the laser oscillation unit device may be introduced to the inside of the plasma vessel from the incident window.

While maintaining an average energy supplied to the plasma lower than an average energy in the case of continuously supplying a high-energy laser power, the present invention allows configuring a profile of spectral intensity obtained as a result of instantaneous supply of the high-energy laser power equivalent to a profile in the case of continuous supply of the high-energy laser power, thereby increasing emission intensity in an ultraviolet region with a short wavelength.

Accordingly, emission of light, which yields an efficient ultraviolet region, can be obtained without the need for a large-scale laser oscillation unit.

### BRIEF DESCRIPTION OF THE DRAWINGS

FIG. 1 illustrates a laser-driven light source device according to an embodiment of the present invention.

FIG. 2 is a cross-sectional view of an exemplary plasma vessel used in the light source device shown in FIG. 1.

FIG. 3 illustrates an intensity distribution of laser light emitted from the light source device shown in FIG. 1.

FIG. 4A shows the relationship between laser power and time according to a conventional arrangement.

FIG. 4B shows the relationship between the laser power and time according to the light source device of the embodiment of the invention.

FIG. 4C shows the relationship between spectral intensity and wavelength according to the conventional arrangement.

FIG. 4D shows the relationship between the spectral intensity and wavelength according to the embodiment of the invention.

FIG. 5 shows a conventional laser-driven light source device.

FIG. 6A and FIG. 6B are views useful to describe incident laser light and a plasma according the light source device shown in FIG. 5.

FIG. 7A to FIG. 7D are views useful to describe intensity and a spectral distribution of the laser light according to a conventional arrangement.

### DETAILED DESCRIPTION

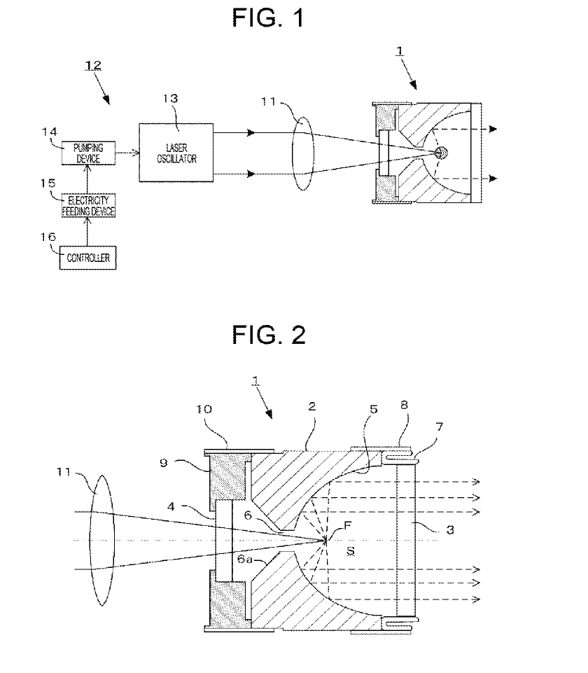

An embodiment of the present invention will be described with reference to the accompanying drawings. Referring to FIG. 1, illustrated is a laser-driven light source device according to one embodiment of the present invention. A plasma vessel 1 contains and seals an ionizable discharge medium such as noble gas and mercury therein.

Laser light emitted from a laser oscillation unit 12 is condensed by a condensing lens 11 and enters the plasma vessel 1.

The laser oscillation unit 12 includes a laser resonator 13, a pumping device 14 connected to the laser resonator 13, an electricity feeding device 15, which is connected to the pumping device 14 and feeds power to the pumping device 14, and a control unit 16, which is connected to the electricity feeding device 15 and controls the electricity feeding device 15.

The laser resonator 13 has a pair of reflecting mirrors, namely, a partial reflection mirror and a total reflection mirror. A laser medium is arranged in an optical path inside the laser resonator 13.

The pumping device 14 configured to excite the laser medium is coupled to the laser resonator 13. The pumping device 14 may supply light to excite the laser medium, and may have a plurality of laser diodes (LDs) and/or a lamp.

The pumping device 14 is coupled to the electricity feeding device 15 that is controlled by the control unit 16.

The control unit 16 adjusts the power feeding from the electricity feeding device 15 to the pumping device 14 in response to a signal from a function generator (e.g., a sign signal or a rectangular wave signal) at a constant cycle. The pumping device 14 excites the laser resonator 13 by energy that corresponds to the power received from the electricity feeding device 15.

FIG. 2 illustrates the detail of the exemplary plasma vessel 1. The plasma vessel 1 includes a pillar-shaped body 2 made of a ceramics material or a similar material, a light emission window 3 disposed at a front surface of the body 2 (right surface of the body 2 in FIG. 2), and a light incident window 4 disposed at a rear surface of the body 2.

A reflecting surface 5 is formed on the front surface side of the body 2. The reflecting surface 5 is a concave surface in this embodiment. A laser light passing hole 6 that penetrates the concave reflecting surface 5 in an optical axis direction is made at the center of the concave reflecting surface 5. The rear end of the laser light passing hole 6, i.e., the light incident portion is chamfered, forming a tapered surface 6a. The tapered surface 6a is configured so as to avoid that the condensed laser light be cut off at the entrance of the laser light passing hole 6 when the laser light is introduced to the laser light passing hole 6 through the light incident window 4.

The concave reflecting surface 5 may be formed into a parabolic shape or an elliptical shape. In this embodiment, the concave reflecting surface 5 is a reflecting surface with the parabolic shape. On the concave reflecting surface 5, a metal deposition film is provided. Specifically, aluminum or the like is deposited on the reflecting surface 5. Alternatively, a dielectric multilayer film may be provided on the reflecting surface 5.

The light emission window or the light exit window 3 disposed in front of the reflecting surface 5 has a transparency to ultraviolet light and the light incident window 4 at the rear of the reflecting surface 5 has a transparency to laser light. Both of the windows 3 and 4 are made of a vitreous material such as crystal, sapphire, and quartz glass.

The light emission window 3 whose outer peripheral surface is metalized is bonded with an elastic ring member 7 by brazing with a silver solder and the like. On the other hand, a metallic tubular body 8 is bonded to the metalized front end portion of the body 2 by brazing. The ring member 7 and the metallic tubular body 8 are welded and bonded together by, for example, TIG welding or laser beam welding. Thus, the light emission window 3 is mounted to the front opening of the body 2.

Similarly, the light incident window 4 with the metalized outer peripheral surface is bonded to a metal block 9 by brazing, and a metallic tubular body 10 is bonded to the metalized rear end portion of the body 2 by brazing. The metal block 9 is welded to the metallic tubular body 10. Accordingly, the light incident window 4 is mounted to the rear opening of the body 2.

The body 2, the light emission window 3, and the light incident window 4 thus assembled constitute the plasma vessel 1, and the inside of the plasma vessel 1 defines a sealed (closed) space S. The sealed space S contains and seals a noble gas such as xenon gas, krypton gas, and argon gas and a light emission gas such as mercury gas, depending upon the emission wavelength. The noble gas and the light emission gas are examples of the discharge medium.

The laser light from the laser oscillation unit 12 enters the light incident window 4 of the plasma vessel 1 while being condensed by the condensing lens 11. Then, the laser light is condensed at a focal point (focus position) F of the concave reflecting surface 5. Thus, the plasma is generated at and around the focal point F, and excitation light generated by excitation of the discharge medium is reflected by the concave reflecting surface 5 and exits from the light emission window 3 to the outside.

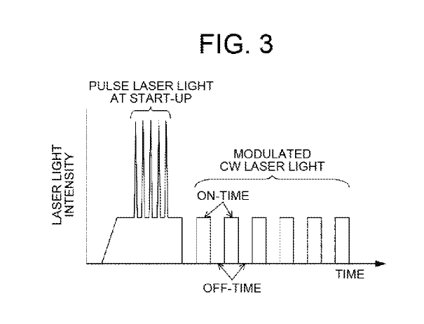

As illustrated in FIG. 3, the laser oscillation unit 12 emits the CW laser light and also emits the pulse laser light in a superimposing manner during the start-up period (ignition period), thus generating the plasma (firing source) by the irradiation with the pulse laser light. The plasma (firing source) is maintained by energy from the CW laser light emitted simultaneously. During the start-up period, the output of the CW laser light is not modulated.

After the start-up period, the illustrated embodiment controls the output of the CW laser light that is used to maintain the plasma. The control unit 16 performs on/off control on the electricity feeding device 15 such that the electricity feeding device 15 is activated during a predetermined on-time and deactivated in a predetermined off-time to modulate the output of the CW laser light emitted from the laser oscillation unit 12.

The on-time is several μsec to several msec in this embodiment. The control unit 16 controls the off-time such that the plasma does not disappear due to the off-time.

Considering that the pulse width of the pulse laser light is in the order of ns, the on-time has a width at least 1000 times or more (i.e., at least 1000 ns).

Since the light source device of the embodiment intermittently emits the laser light, it might not be said that the laser light is “continuous (CW) laser light” when considering just the term. However, the embodiment of the present invention provides the on-time and the off-time and supplies the laser light intermittently in the case where the CW (continuous) laser light is suppled; therefore, the description expresses this as the modulation of the output of the (CW) laser light in comparison with the pulse laser light. In other words, the on-time and the off-time in the embodiment do not relate to the pulse laser light, but they only relate to the continuous laser light.

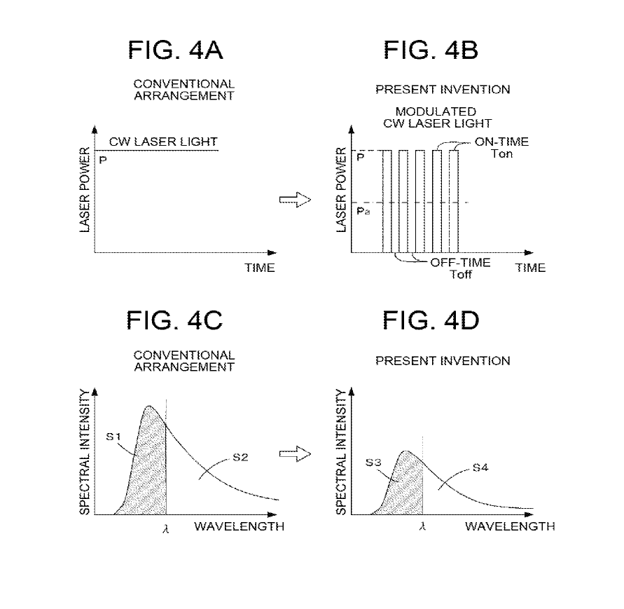

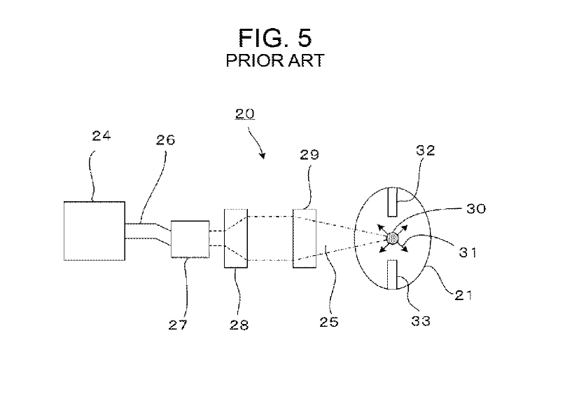

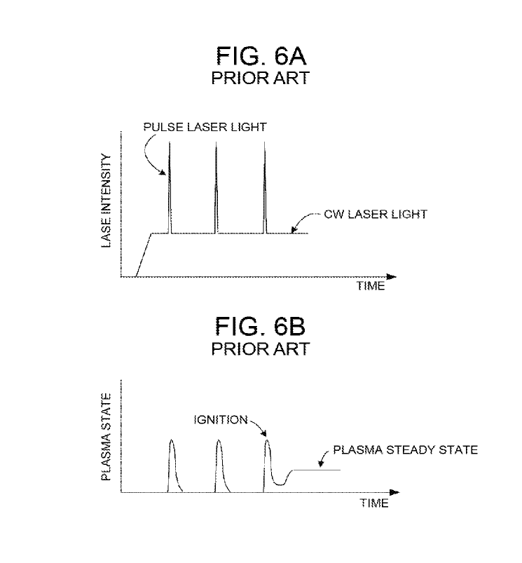

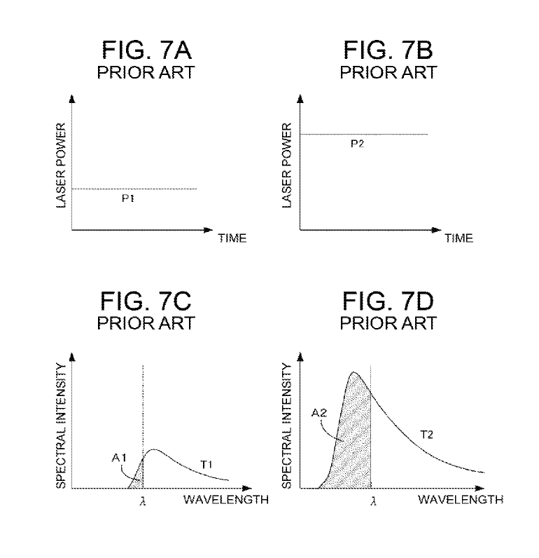

As described above, the present invention modulates the output of the CW laser light to maintain the plasma. Referring to FIG. 4A-4D, the following will describe the advantages of such modulation.

Since the plasma is intermittently irradiated with the laser light, the average laser power (intensity) in this embodiment is lower than the case where the laser light is continuously emitted to the plasma. The average laser power is calculated including the period during which the laser light is not emitted to the plasma (off-time).

If the emitted laser power is represented by P, the period during which the laser light is emitted to the plasma (on-time) is represented by Ton, and the period during which the laser light is not emitted to the plasma (off-time) is represented by Toff, the average energy Pa is given by the following equation:

Pa=P×Ton/(Ton+Toff).

Since the laser power P during the on-time is identical (the laser power does not change), the plasma temperature is identical (plasma temperature does not change) and the shape of the emission spectrum from the plasma is identical.

In FIG. 4C, an area with the wavelength λ or less in the spectrum is represented by S1, and an area with the wavelength λ or more is represented by S2 when the laser power of the CW laser light is represented by P (FIG. 4A). FIGS. 4A and 4C are derived from a conventional arrangement. When the CW laser light is modulated, an area with the wavelength λ or less is represented by S3, and an area with the wavelength λ or more is represented by S4, as shown in FIG. 4D. FIGS. 4B and 4D are derived from the embodiment of the present invention. Then, the following equation is obtained.

S1:S2=S3:S4

For example, when λ is 200 nm, a ratio of the vacuum ultraviolet area S1 (200 nm or less) to the remaining area S2 (200 nm or more) in FIG. 4C is equal to (or similar to) a ratio of the vacuum ultraviolet area S3 (200 nm or less) to the remaining area S4 (200 nm or more) in FIG. 4C.

Thus, the intermittent input of electricity (i.e., the on/off control by the control unit 16) ensures obtaining the spectrum having a profile similar to that of the spectrum obtained when a large input is continuously input even when the average laser power is decreased. The average laser power in FIG. 4A is P, and the average laser power in FIG. 4B is Pa. Pa is lower than P.

As described above, decreasing the average laser power allows both of avoiding the enlargement of the entire laser oscillation unit and efficiently increasing emission intensity in the ultraviolet area (for example, the vacuum ultraviolet area) with a predetermined short wavelength.

In other words, with the use of the similar average laser power for the continuous power supply (conventional arrangement) and the intermittent power supply (the present invention), the present invention ensures obtaining the emission spectrum with the increased ultraviolet area.

It should be noted that the ignition source used to generate the plasma (firing source) at the start-up (ignition) period is not limited to the pulse laser light. For example, a pair of electrodes may be disposed in the plasma vessel, and the plasma may be generated by applying a high voltage between these electrodes and causing a dielectric breakdown.

### EXAMPLES

The following passages will describe one working example.
Plasma vessel: tubular bulb made of synthetic quartz glass (with electrodes for ignition)
Sealed gas: Xe 10 atm
Laser: fiber laser (M2≈1.1, beam diameter is 14 mm)
Wavelength: 1070 nm
Condensing lens: f=40 mm
Laser output: Modulated CW laser, average output is 211 W (on-time is 80 μs, off-time is 80 μs, peak value is 419 W)

The above-described laser-driven light source device of the present invention was compared with a comparative example using a CW laser (no modulation is applied to the CW laser) with the output of 212 W.

The output of VUV (wavelength: 160 nm to 180 nm) was 9,770 (arbitrary unit: a.u.) in the comparative example if it was expressed by a spectrum integrated value. On the other hand, the output of VUV was 11,864 in the working example of the present invention. Thus, although the average laser output was identical, the VUV output of the present invention was increased to about 1.2 times.

As described above, the laser-driven light source device according to the present invention irradiates the plasma with the laser light output of which is modulated such that the on-time becomes several μsec to several msec and the off-time becomes the period that does not cause the disappearing of the plasma, when the laser light is directed to the inside of the plasma vessel to maintain the plasma in the plasma vessel. Accordingly, although the average laser output is small, the spectrum similar to the spectrum obtained by the large output can be obtained. Thus, while the enlargement of the laser oscillation unit is avoided, and the emission intensity of the ultraviolet region with the predetermined short wavelength or less can be efficiently increased.

This application is based on Japanese Patent Application No. 2017-136778 filed in Japan on Jul. 13, 2017, and the entire disclosure thereof is incorporated herein by reference.

What is claimed is:

1. A laser-driven light source device comprising:
a laser oscillation unit configured to emit laser light;
a plasma vessel configured to contain and seal a discharge medium therein; and,
an optical system configured to condense the laser light emitted from the laser oscillation unit, and direct the laser light to an inside of the plasma vessel to generate a plasma,
the laser oscillation unit including a control unit configured to perform an on/off control on generation of the laser light to modulate an output of the laser light such that the laser light is generated during an on-time of several μsec to several msec and the laser light is not generated during an off-time, the off-time being decided to avoid disappearing of the plasma in the plasma vessel.

2. The laser-driven light source device according to claim 1, wherein the laser oscillation unit includes:
a laser resonator that contains a laser medium therein;
a pumping device configured to excite the laser medium; and
an electricity feeding device configured to feed a power to the pumping device, and
the control unit is configured to perform the on/off control on the electricity feeding device such that the on-time becomes several μsec to several msec and the off-time becomes the period that is sufficiently short to avoid the disappearing of the plasma.

3. The laser-driven light source device according to claim 1, wherein the plasma vessel includes a body having a front opening and a rear opening, a light incident window disposed at the rear opening of the body, and a light emission window disposed at the front opening of the body,
the body has a reflecting surface, and the reflecting surface is a concave surface,
a closed and sealed space is formed by the body, the incident window, and the emission window,
the sealed space contains and seals the discharge medium therein, and
the laser light from the laser oscillation unit is introduced to the inside of the plasma vessel from the incident window.

4. The laser-driven light source device according to claim 2, wherein the plasma vessel includes a body having a front opening and a rear opening, a light incident window disposed at the rear opening of the body, and a light emission window disposed at the front opening of the body,
the body has a reflecting surface, and the reflecting surface is a concave surface,
a closed and sealed space is formed by the body, the incident window, and the emission window,
the sealed space contains and seals the discharge medium therein, and
the laser light from the laser oscillation unit is introduced to the inside of the plasma vessel from the incident window.

5. The laser-driven light source device according to claim 3, wherein the emission window is transparent to ultraviolet light, and the incident window is transparent to the laser light.

6. The laser-driven light source device according to claim 4, wherein the emission window is transparent to ultraviolet light, and the incident window is transparent to the laser light.

7. The laser-driven light source device according to claim 3, wherein the optical system includes a condensing lens to condense the laser light emitted from the laser oscillation unit such that the condensed laser light is condensed to a focal point of the reflecting surface of the body.

8. The laser-driven light source device according to claim 4, wherein the optical system includes a condensing lens to condense the laser light emitted from the laser oscillation unit such that the condensed laser light is condensed to a focal point of the reflecting surface of the body.

9. The laser-driven light source device according to claim 1, wherein the control unit performs the on/off control after a start-up period of the light source device.

10. The laser-driven light source device according to claim 2, wherein the control unit performs the on/off control after a start-up period of the light source device.
